(19) United States
(12) Patent Application Publication
(10) Pub. No.: US 2008/0158907 A1
(43) Pub. Date: Jul. 3, 2008

(54) BACKLIGHT MODULE HAVING LIGHT GUIDE PLATE WITH FLUORESCENT LAYER THEREON

(75) Inventors: KAI-CHI LIN, Hsinchu (TW); TSUNG-JEN LIN, Hsinchu (TW)

Correspondence Address: PCE INDUSTRY, INC.;ATT. CHENG-JU CHIANG, 458 E. LAMBERT ROAD, FULLERTON, CA, 92835, US

(73) Assignee: FITIPOWER INTEGRATED TECHNOLOGY, INC, Hsinchu (TW)

(21) Appl. No.: 11/937,343

(22) Filed: Nov. 8, 2007

(30) Foreign Application Priority Data
Dec. 27, 2006 (TW) 095149077

(51) Int. Cl. F21V 9/00

(52) U.S. Cl. 362/606

(57) ABSTRACT

A backlight module (100) includes a light guide plate (110) having a light incident surface (111) and a light emitting surface (112), a fluorescent layer (120) arranged on the light emitting surface thereof, and a light source (130) disposed adjacent to the light incident surface of the guide plate for emitting towards the incident surface of the light guide plate, wherein the light is configured for stimulating the fluorescent layer such that light exiting from the light guide plate appears to be white light.

### BACKGROUND

1. Field of the Invention

The present invention relates to backlight modules and, particularly to a backlight module having a light guide plate with a fluorescent layer thereon.

2. Description of Related Art

Nowadays, liquid crystal materials are widely utilized in various liquid crystal displays having different sizes for different applications, such as TVs, liquid crystal projectors, mobile telephones, personal digital assistants (PDA), etc. Because liquid crystal itself cannot emit light, light sources must be utilized to illuminate liquid crystal for image display. The light sources are called backlight sources since they are usually configured behind liquid crystal panels. A combination of all components behind the liquid crystal panels, including the light sources, is generally referred to as a backlight module. Usually, the backlight module needs to emit approximate natural white light, thus the liquid crystal displays may display actual images.

Light emitting diodes (LEDs) have many advantages, such as high brightness, low energy consumption, long service life, and so on. Therefore, the LEDs are usually employed in the backlight module for being used as the light sources.

However, light emitting diode chips cannot emit directly approximate natural white light. Therefore, the LEDs usually employ specific phosphor powder packeted with the light emitting diode chips for emitting the approximate natural white light. However, since the LEDs usually have an arc-shaped surface, the phosphor powder packeted therein are distribute nonuniformly such that the approximate natural white light emitted from the LEDs have a poor uniformity and a low efficiency. Thus, the backlight modules employing the LEDs have a poor uniformity and a low efficiency.

What is needed, therefore, is a backlight module emitting approximate natural white light uniform with a high efficiency, and a method thereof.

### SUMMARY

A backlight module according to a present embodiment, includes a light guide plate having a light incident surface and a light emitting surface, a fluorescent layer arranged on the light emitting surface thereof, and a light source disposed adjacent to the light incident surface of the guide plate for emitting towards the incident surface of the light guide plate, wherein the light is configured for stimulating the fluorescent layer such that light exiting from the light guide plate appears to be white light.

A backlight module according to another present embodiment, includes a light guide plate having a light incident surface and a light emitting surface, a fluorescent layer arranged on the light incident surface thereof, and a light source disposed adjacent to the light incident surface of the light guide plate for emitting light towards the incident surface of the light guide plate, wherein the light is configured for stimulating the fluorescent layer such that light emitting from the light guide plate appears to be white light.

The present backlight module employs the fluorescent layer on the light incident surface or the light emitting surface of the light guide plate, the phosphor powder of the fluorescent layer are distributed uniformly on the light guide plate. Therefore, the whole backlight module emits the uniform white light by cooperating the fluorescent layer with the light emitting diode.

Other advantages and novel features of the present invention will become more apparent from the following detailed description of preferred embodiment when taken in conjunction with the accompanying drawings, in which:

### BRIEF DESCRIPTION OF THE DRAWINGS

Many aspects of the present backlight module can be better understood with reference to the following drawings. The components in the drawings are not necessarily to scale, the emphasis instead being placed upon clearly illustrating the principles of the present backlight module. Moreover, in the drawings, like reference numerals designate corresponding parts throughout the several views.

FIG. 1 is a schematic, side view of a backlight module according to a first preferred embodiment of the present invention;

FIG. 2 is a schematic, side view of a backlight module according to a second preferred embodiment of the present invention;

FIG. 3 is a schematic, side view of a backlight module according to a third preferred embodiment of the present invention;

FIG. 4 is a schematic, side view of a backlight module according to a fourth preferred embodiment of the present invention;

### DETAILED DESCRIPTION OF THE EMBODIMENT

Reference will now be made to the drawings to describe a preferred embodiment of the present backlight module in detail.

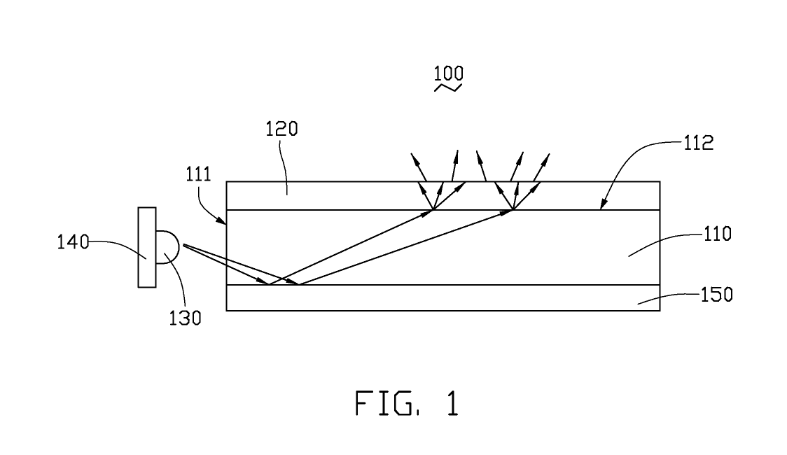

Referring to FIG. 1, a backlight module 100 in accordance with a first embodiment, includes a light guide plate 110 having a light incident surface 111 and a light emitting surface 112, a fluorescent layer 120 arranged on the light emitting surface 112 thereof, and a light source 130 disposed adjacent to the light incident surface 111 thereof. In this exemplary embodiment, the light source 130 is a light emitting diode. Furthermore, the backlight module 100 may further include a support member 140 for holding the light emitting diode 130. The support member 140 may be a printed circuit board.

The light guide plate 110 is a transparent plate, and can be made of a material selecting from a group consisting of polymethyl methacrylate, methacrylic resin, polyacrylic ester, polycarbonate and polythene resin, etc. The light guide plate 110 may be a flat plate or a wedge-shaped plate. In this exemplary embodiment, the light emitting surface 112 is a flat surface, which the fluorescent layer 120 is arranged on. The light incident surface 111 is substantially perpendicular to the light emitting surface 112 of the light guide plate 110.

The fluorescent layer 120 is a layer comprised of phosphor powder. The phosphor powder of the fluorescent layer 120 is selected according to the light emitting diode 130. Specifically, the fluorescent layer 120 may be comprised of red phosphor powder for generating the red light, and green phosphor powder for generating the green light, if the light emitting diode 130 is a blue light emitting diode for emitting the blue light. The light emitting diode 130 is configured for emitting the blue light for stimulating the fluorescent layer 120 to emit the red light and the green light such that the blue light emitted from the light emitting surface 112 of the light guide plate 110, and the red light and the green light emitted from the fluorescent layer 120 cooperatively appear to be the white light. Alternatively, the fluorescent layer 120 may be comprised of red phosphor powder for generating the red light, green phosphor powder for generating the green light and blue phosphor powder for generating the green light, if the light emitting diode 130 is a purple light emitting diode for emitting the purple light or an ultraviolet light emitting diode for emitting the ultraviolet light. The light emitting diode 130 is configured for emitting the purple light or the ultraviolet light to stimulate the fluorescent layer 120 to emit the white light.

The fluorescent layer 120 may be formed on the light emitting surface 112 of the light guide plate 110 by a method describes as following. The method includes: mixing the phosphor powder with a solvent; coating the mixture of the phosphor powder and the solvent on the light emitting surface 112 of the light guide plate 110; removing the solvent to form the fluorescent layer 120. The solvent is a volatile solvent, such as acetone. The mixture can be coated on the light emitting surface 112 of the light guide plate 110 by a mechanism coating method, a spin coating method, or a spraying method to make the phosphor powder is distributed uniformly on the light emitting surface 112. The solvent can be removed by a method selected from a group consisting of placing for a certain time, heating and vacuumizing, etc. For example, the light guide plate 110 having the mixture coated thereon can be placed in room temperature for a certain time to volatilize the volatile solvent, such that the phosphor powder of the mixture is left on the light emitting surface 112 of the light guide plate 10 to form the fluorescent layer 120. Alternatively, the light guide plate 110 having the mixture coated thereon can be heated by a heating device, such as furnace, to volatilize the volatile solvent for forming the fluorescent layer 120. Alternatively, the light guide plate 110 having the mixture coated thereon can be placed in a sealed chamber and be vacuumized by a pump to volatilize the volatile solvent for forming the fluorescent layer 120.

The fluorescent layer 120 may be formed on the light emitting surface 112 of the light guide plate 110 by another method described as following. The method includes: mixing the phosphor powder with a transparent colloid; coating the mixture on the light emitting surface 112 of the light guide plate 110; solidifying the mixture to form the fluorescent layer 120. In this exemplary method, the transparent colloid can be epoxy resin. The mixture can be solidified by placing or heating.

The fluorescent layer 120 also may be formed on the light emitting surface 112 of the light guide plate 110 by other method described as following. The method includes: mixing the phosphor powder with a transparent material in a module to form a transparent plate having the phosphor powder; attaching the transparent plate having the phosphor powder on the light emitting surface 112 of the light guide plate 110 to form the fluorescent layer 120. In this exemplary method, the transparent material can be selected from a group consisting of polycarbonate, polymethyl methacrylate, and epoxy resin having high light transmission ratio.

The fluorescent layer 120 may be formed on the light emitting surface 112 of the light guide plate 110 by other method described as following. The method includes: providing a target composed of phosphor powder; impacting the target by electron beams for forming the fluorescent layer 120 on the light emitting surface 112 of the light guide plate 110.

Furthermore, the backlight module 100 further includes a reflective member 150 arranged on an opposite surface of the light guide plate 110 to the light emitting surface 112 thereof.

In operation, the light emitting diode 130 emits light of a desired spectrum, such as the blue light, the purple light, or the ultraviolet light. The light is directed into the light guide plate 110 and may be reflected by the reflective plate 150, and is emitted through the emitting surface (the flat surface 112) of the light guide plate 110 so as to irradiate the fluorescent layer 120. If the fluorescent layer 120 is comprised of the red phosphor powder and the green phosphor powder, part of the blue light emitted from the light emitting diode 130 are converted into the red light and the green light after irradiating the fluorescent layer 120. Thus, the red light, the green light and the blue light are mixed into approximate nature white light after passing through the fluorescent layer 120. If the fluorescent layer 120 is comprised of the red phosphor powder, the green phosphor powder and the blue phosphor powder, part of the purple light or the ultraviolet light emitted from the light emitting diode 130 are converted into red light, the green light and the blue light after irradiating the fluorescent layer 120, thus the red light, the green light and the blue light are mixed into the approximate nature white light after passing through the fluorescent layer 120.

Compared with the conventional backlight module, since the present backlight module 100 employs the fluorescent layer 120 coated on the light emitting surface 112 of the light guide plate 110, the phosphor powder of the fluorescent layer 120 are distributed uniformly on the light emitting surface 112 of the light guide plate 110. Therefore, the whole backlight module 100 emits the uniform approximate nature white light by cooperating the fluorescent layer 120 with the light emitting diode 130.

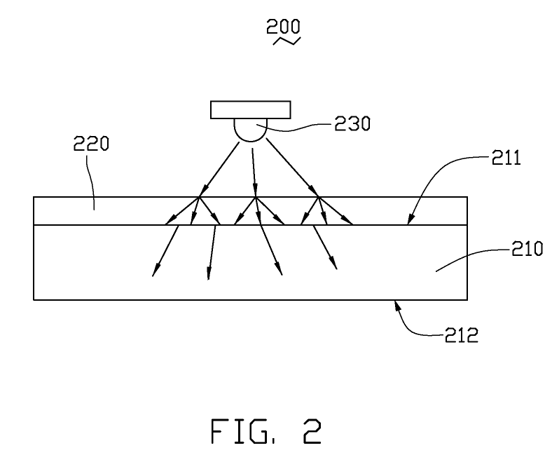

Referring to FIG. 2, a backlight module 200 in accordance with a second embodiment is shown. The backlight module 200 is similar to that of the first embodiment, except that the fluorescent layer 220 is arranged on the light incident surface 211 of the light guide plate 210, and the light emitting diode 230 is disposed adjacent to the light incident surface 2112 of the light guide plate 210 for emitting light towards the incident surface 211 thereof. The light is configured for stimulating the fluorescent layer 220 such that the light stimulated from the light guide plate 210 appears to be white light. The light incident surface 211 and the light incident surface 212 are arranged on opposite sides of the light guide plate 210.

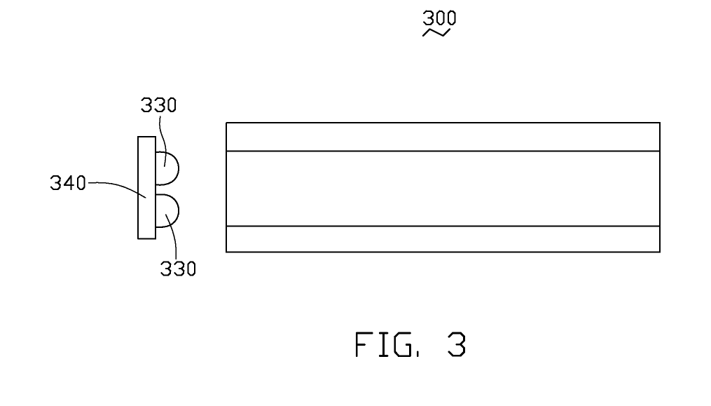

Referring to FIG. 3, a backlight module 300 in accordance with a third embodiment is shown. The backlight module 300 is similar to that of the first embodiment, except that the backlight module 300 includes a plurality of light emitting diode 330 fixed on the support member 340. In this exemplary embodiment, the backlight module 300 includes two light emitting diodes 330 fixed on the support member 340.

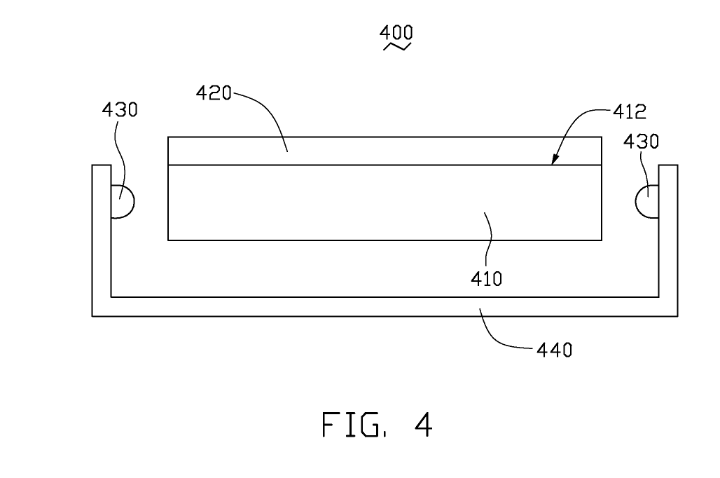

Referring to FIG. 4, a backlight module 400 in accordance with a fourth embodiment is shown. The backlight module 400 is similar to that of the first embodiment, except that the support member 440 is made of a reflective material, such as metal, and surrounds the whole surface of the light guide plate except the light emitting surface 412. The backlight module 400 includes two light emitting diodes 430 arranged respectively at two opposite sides of the light guide plate 410.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module, comprising:
a light guide plate having a light incident surface and a light emitting surface and a fluorescent layer arranged on the light emitting surface thereof; and
a light source disposed adjacent to the light incident surface of the guide plate for emitting light towards the incident surface of the light guide plate, wherein the light is configured for stimulating the fluorescent layer such that light exiting from the light guide plate appears to be white light.

2. The backlight module as claimed in claim 1, wherein a light source is configured for emitting blue light to stimulate the fluorescent layer to emit red light and green light, the blue light exiting from the emitting surface, and the red light and green light emitted from the fluorescent layer cooperatively appearing to be the white light.

3. The backlight module as claimed in claim 2, wherein the fluorescent layer is comprised of red phosphor powder for generating the red light and green phosphor powder for generating the green light.

4. The backlight module as claimed in claim 3, wherein the light source is a blue light emitting diode for emitting blue light.

5. The backlight module as claimed in claim 1, wherein the light source is configured to emitting one of purple light and ultraviolet light to stimulate the fluorescent layer to emit the white light.

6. The backlight module as claimed in claim 5, wherein the fluorescent layer is comprised of red phosphor powder for generating the red light, green phosphor powder for generating the green light and blue phosphor powder for generating the blue light.

7. The backlight module as claimed in claim 6, wherein and the light source is one of a purple light emitting diode for emitting the purple light and a ultraviolet light emitting diode for emitting the ultraviolet light.

8. The backlight module as claimed in claim 1, further comprising a reflecting member arranged on an opposite side of the light guide plate to the light emitting surface thereof.

9. The backlight module as claimed in claim 1, wherein the light incident surface is substantially perpendicular to the light emitting surface of the light guide plate.

10. A backlight module comprising:
a light guide plate having a light incident surface and a light emitting surface and a fluorescent layer arranged on the light incident surface thereof; and
a light source disposed adjacent to the light incident surface of the guide plate for emitting light towards the incident surface of the light guide plate, wherein the light is configured for stimulating the fluorescent layer such that light exiting from the light guide plate appears to be white light

11. The backlight module as claimed in claim 10, wherein the light emitting surface and the light incident surface are arranged on opposite sides of the light guide plate.

12. The backlight module as claimed in claim 10, wherein a light source is configured for emitting blue light to stimulate the fluorescent layer to emit red light and green light, the blue light exiting from the emitting surface, and the red light and green light emitted from the fluorescent layer cooperatively appearing to be the white light.

13. The backlight module as claimed in claim 12, wherein the fluorescent layer is comprised of red phosphor powder for generating the red light and green phosphor powder for generating the green light.

14. The backlight module as claimed in claim 13, wherein the light source is a blue light emitting diode for emitting blue light.

15. The backlight module as claimed in claim 10, wherein the light source is configured to emitting one of purple light and ultraviolet light to stimulate the fluorescent layer to emit the white light.

16. The backlight module as claimed in claim 15, wherein the fluorescent layer is comprised of red phosphor powder for generating the red light, green phosphor powder for generating the green light and blue phosphor powder for generating the blue light.

17. The backlight module as claimed in claim 16, wherein and the light source is one of a purple light emitting diode for emitting the purple light and an ultraviolet light emitting diode for emitting the ultraviolet light.
